(19) United States
(12) Patent Application Publication
(10) Pub. No.: US 2018/0021735 A1
(43) Pub. Date: Jan. 25, 2018

(54) METHOD FOR IDENTIFYING THE TYPE OF CLOGGING IN A MEMBRANE FILTRATION APPARATUS

(71) Applicant: REALCO S.A., Louvain-la-Neuve (BE)

(72) Inventors: Gordon BLACKMAN, Lasne (BE); Sébastien FASTREZ, Mons (BE)

(21) Appl. No.: 15/540,082

(22) PCT Filed: Dec. 29, 2015
(86) PCT No.: PCT/EP2015/081314

§ 371 Date: Jun. 27, 2017

(30) Foreign Application Priority Data
Dec. 31, 2014 (BE) BE2014/5166
Mar. 31, 2015 (BE) BE2015/5200

(51) Int. Cl. B01D 65/02; A23C 7/02; C11D 3/386; B01D 65/10

(52) U.S. Cl. CPC B01D 65/02; B01D 65/10; A23C 7/02; C11D 3/38618; C11D 3/38627; C11D 3/38645; C11D 3/38636; B01D 2321/166

(57) ABSTRACT

The present invention relates to a method for processing a membrane filtration apparatus having at least one fluid inlet and at least one fluid outlet, said method comprising a first step a) of supplying and flowing a first enzyme solution comprising at least one protease through said membrane filtration apparatus for a first predetermined time period, said first step a) being followed by a first measurement, performed at said at least one fluid inlet and/or said at least one fluid outlet of said membrane filtration apparatus, of at least one first parameter value making it possible to characterize the fluid flowing within said membrane filtration apparatus, said at least one first measured parameter value being compared to a value of the same parameter measured before step a).

The present invention relates to a method for treating a membrane filtration apparatus having at least one fluid inlet and at least one fluid outlet, said method comprising a first step a) of supplying and flowing, through said membrane filtration apparatus for a first predetermined period of time, a first enzyme solution comprising at least one protease, said first step a) being followed by a first measurement, carried out at said at least one fluid inlet and/or at said at least one fluid outlet of said membrane filtration apparatus, of at least one first value of a parameter for characterising the fluid flowing in said membrane filtration apparatus, this at least one first measured value of a parameter being compared with a measured value of this same parameter prior to step a).

Such a method for treating a membrane filtration apparatus is known from the publication by Yu et al. (Enzymatic treatment for controlling irreversible membrane fouling in cross-flow humic acid-fed ultrafiltration. Journal of Hazardous Materials 2010, 177: 1153-1158).

Filtration is a separation method for separating the constituents of a mixture that has a liquid phase and a solid phase through a porous medium. The use of a filter or membrane makes it possible to retain the particles of heterogeneous mixture that are coarser than the openings in the filter (porosity). The liquid that has undergone the filtration is called the filtrate or permeate, while the fraction retained by the filter is called the residue, retentate or cake. A filtration on membrane (membrane filtration) is therefore a physical separation method taking place in the liquid phase through a membrane, the aim being to purify, fraction or concentrate the species in suspension in a solvent.

By way of example, in the milk-industry field, membrane filtration is used for manufacturing products derived from milk such as powdered milk, yoghurts, cheeses and standardised milks (skimmed, semi-skimmed, whole milk, etc.).

Unfortunately, membrane filtration apparatus suffers from problems of frequent clogging, of particles of different natures issuing from the heterogeneous mixture fixed in and on the pores of the membrane and ending up by being responsible for saturation thereof. Such clogging has a direct impact on the production line of an industry, for example of a milk industry, since it is necessary to proceed punctually with the stoppage of the production line, empty the membrane filtration apparatus and finally proceed with cleaning of the latter in order to unclog the pores of the membranes.

Currently, this unclogging of the pores of the membranes is based in particular on the injection of enzyme solutions in the membrane filtration apparatus in order to detach therefrom the particles responsible for the clogging. Typically an enzyme cocktail comprising a whole series of enzymes is injected then caused to circulate in the apparatus in order to proceed with a detachment of the cakes clogging the filters. However, this technique has several drawbacks, the main one of which is the injection of an enzyme cocktail comprising various enzymes, which are not necessarily suitable for dislodging the particles responsible for a given clogging. This is because, from one apparatus to another, and depending on the heterogeneous mixture treated (filtered), the cakes forming at the membranes differ and it is consequently improbable for a given enzyme cocktail, effective for a particular apparatus is also effective for another apparatus. In practice, at the present time, large volumes of enzyme solutions are therefore injected in order to treat clogging overall without truly knowing the nature thereof. This way of proceeding is expensive, unecological and far from being optimal. This is because some enzymes injected in the system will not act therein since the clogging may consist of particles for which these enzymes may not offer any affinity: they will therefore not make it possible to dislodge these particles responsible for clogging, with which they are incapable of interacting.

Another approach, such as for example the one disclosed in the document WO 2009/089587, is based on removing, from the filtration apparatus, the filters suffering from clogging before subjecting them to soaking under agitation in vessels containing enzyme solutions in order to unclog the filters. This is particularly constraining since it is necessary to dismantle the filtration apparatus at least partially.

The aim of the invention is to overcome these drawbacks by procuring a method for treating a membrane filtration apparatus in order to avoid any injection of unnecessary enzymes and to ensure a targeted detachment of the particles responsible for the formation of cake on the membranes, without having to remove the filters from the filtration apparatus. The aim of this is to reduce the volumes of enzyme solutions used and to avoid any injection of unnecessary enzymes in the filtration apparatus. Moreover, as indicated above, the objective of the invention is to make it possible to proceed with an in-place treatment of the filters, that is to say without having to remove the latter from the filtration apparatus.

To solve this problem, a method as indicated at the start is provided according to the invention, characterised in that it comprises, for identifying the nature of the clogging present in said membrane filtration apparatus, a second step b) of supplying and flowing in said membrane filtration apparatus, for a second predetermined period of time, a second enzyme solution comprising at least one enzyme other than a protease, said second step b) being followed by a second measurement, carried out at said at least one fluid inlet and/or at said at least one fluid outlet of said membrane filtration apparatus, of at least one second value of a parameter for characterising the fluid flowing in said membrane filtration apparatus, this at least one second measured value of a parameter being compared with a measured value of this same parameter prior to step b), said steps a) and b) being implemented in any order.

Preferably, according to the method according to the invention, said value of a parameter measured at said at least one fluid inlet and/or said at least one fluid outlet of said membrane filtration apparatus is a value of a parameter for characterising the dynamics of fluid flowing therein (for example the flowrate of the fluid or the transmembrane pressure) or a value of a parameter for characterising the substances in suspension in the fluid (for example for the protein-particle content in the fluid). Naturally any other parameter for characterising the dynamics or the particulate content of the fluid flowing in the membrane filtration apparatus is suitable in the context of the present invention. For example, pressures at the inlet or outlet of the apparatus or ATP measurements carried out on the fluid at the outlet and/or inlet of the membrane filtration apparatus could be suitable in the context of the present invention.

The measured value of a parameter is compared with a measured value of the same parameter prior to each of steps a) and b) in order to determine to what extent the supplies and flows of the first and second enzyme solutions have an impact on this parameter and therefore on the characteristics of the fluid flowing in said membrane filtration apparatus. Depending on whether or not the measured value differs from the value previously measured at each of steps a) and b), the nature of the clogging can be identified: if a supply and flow of a given enzyme solution comprising a given enzyme reveals a difference between the values measured before (the reference value) and after the steps of supplying and flowing each of the enzyme solutions, this makes it possible to conclude that the clogging of the membrane of the membrane filtration apparatus is at least due to the presence of particles with which the given enzyme of an enzyme solution has a certain affinity.

According to the invention, provision is made for other supplementary steps (a′, a″, . . . b′, b″, . . . ) of supplying and flowing other enzyme solutions can supplement the supplies of the first and second enzyme solutions, measurements of at least one value of a parameter for characterising the fluid flowing in said membrane filtration apparatus then being carried out before and after the supplies and flows of each of these supplementary enzyme solutions (a′, a″, . . . b′, b″, . . . ). For example, according to the invention, a supply and flow of an enzyme solution comprising an enzyme other than a protease or other than the enzyme supplied at the second step b) could be carried out between steps a) and b), before step a) or after step b). In this case, advantageously, the pH of the supplementary enzyme solution will be substantially identical to the pH of the enzyme solutions of steps a) and b), in order to ensure optimum enzymatic activity of the enzymes, said activity depending essentially on the pH of the surrounding environment. These supplementary steps (a′, a″, . . . b′, b″, . . . ) may be carried out successively so as to use a whole series of enzymes, which makes it possible to refine the identification of the nature of the clogging.

Such a method according to the invention makes it possible to precisely identify the nature of the clogging to be treated and more particularly whether the clogging is at least of the protein type and/or related to the nature of the enzyme supplied during the second step b). This is because the supplies of the various enzyme solutions, in parallel with a measurement of at least one value of a parameter carried out at at least one fluid inlet and/or at at least one fluid outlet of the membrane filtration apparatus before and after each of these supplies and flows of the various enzyme solutions, makes it possible to determine the nature of the clogging. As indicated above, the measured values make it possible to characterise the fluid flowing in the filtration apparatus following the supplies and flows of the various enzyme solutions. An increase or decrease in these measured parameter values makes it possible to establish to what extent each of the enzyme solutions injected into the system has an impact on the detachment of the cakes clogging the membranes.

For example, if the measured value is the flowrate at the outlet of the filtration apparatus and this value is increased following the injection and flow of enzyme solution compared with a measured value of this same parameter before the supply of this enzyme solution, this indicates that this enzyme solution has an impact on the detachment of particles responsible for the clogging. In other words, in such a case, this indicates that the enzyme present in the enzyme solution injected has an affinity for the particles clogging the membranes, this enzyme detaching these particles, which no longer clog the membrane or at least to a lesser extent. Consequently a better flow of the enzyme solution takes place and a measurement of a higher flow value at the outlet is observed.

Conversely, if the measured values of the same parameter before and after injection of a given enzyme solution in the membrane filtration apparatus does not vary, this indicates that the enzyme solution in question and therefore that the enzyme in question does not have any impact on the detachment of the particles responsible for the clogging of the membranes and that the clogging is therefore not related to particles with which the enzyme is known to have an affinity.

As indicated above, by proceeding with separate supplies of separate enzyme solutions and by associating measurements of parameter values for characterising the fluid flowing in the membrane filtration apparatus following these separate supplies of different enzyme solutions, the method according to the invention makes it possible to precisely determine which types of particle are present on the membranes and are responsible for the clogging thereof. As a result, downstream of the method according to the invention that made it possible to determine the nature of the clogging, the suitable enzyme formulations precisely targeting the particles clogging the membranes can be prepared before being injected in a type of apparatus. Only the necessary enzymes will therefore be injected into the system without “contaminating” the circuits of the apparatus with enzymes that would have no advantage therein since they would not have any affinity with the particles to be detached from the membranes. This constitutes a considerable saving in terms of use of consumables and makes it possible to reduce the costs related to the cleaning of the membranes. Furthermore, this makes it possible to determine the effective membranes that were a priori not envisaged for proceeding with the cleaning and/or unclogging of the membranes in certain apparatus using by default other enzymes not necessarily suitable.

According to one embodiment of the method according to the invention, said first and said second enzyme solutions having a pH of between 6 and 8, preferentially between 6.5 and 7.5. Such pH values ensure sufficient efficacy of the enzymes such as for example proteases and lipases so that they have sufficient enzyme activity enabling them to interact with and detach protein and/or lipid particles clogging the membrane.

Advantageously, according to the method according to the invention, said second step b) of supplying and flowing a second enzyme solution comprising at least one enzyme other than a protease is based on a supply and a flow of at least one enzyme chosen from the group consisting of a-polysaccharidases (lactase, amylase, alpha-glucosidase, etc.), β-polysaccharidases (β-N-acetylglucosaminidase, cellulase, hemicellulase, β-glucanase, arabanase, pectinase, chitinase, xylanase, dextranase, lysozyme, pullulanase, β-glucisidase, mannanase, etc.), oxidoreductases (laccase, etc.), lyases (pectate lyase, etc.), transferases, lipases and esterases (lysophospholipase, phospholipase, etc.) and mixtures thereof.

Preferably, the method according to the invention also comprises at least one additional step c) of supplying and flowing in said membrane filtration apparatus for a third predetermined period of time a third enzyme solution comprising at least one enzyme chosen from the group consisting of α-polysaccharidases (lactase, amylase, alpha-glucosidase, etc.), β-polysaccharidases (β-N-acetylglucosaminidase, cellulase, hemicellulase, β-glucanase, arabanase, pectinase, chitinase, xylanase, dextranase, lysozyme, pullulanase, β-glucisidase, mannanase, etc.), oxidoreductases (laccase, etc.), lyases (pectate lyase, etc.), transferases, proteases and peptidases (metallo-protease, serine-proteases, exo-peptidase, endo-protease, cystine-protease, etc.), and lipases and esterases (lysophospholipase, phospholipase, etc.) and mixtures thereof, an additional measurement of at least one value of a parameter, making it possible to characterise the fluid flowing in said membrane filtration apparatus, then being able to be carried out at said at least one fluid inlet and/or said at least one fluid outlet of said membrane filtration apparatus following this additional step c), this at least one measured value of a parameter being compared with a measured value of this same parameter prior to this additional step c).

If the proteases and for example the lipases (if, by way of example, at least one lipase is supplied during step b)) make it possible to identify the presence of protein and lipid particles clogging the membrane (these two types of particle frequently being responsible for clogging), provision is made, according to the invention, for using at least one other additional enzyme in order to determine whether the clogging is due to the conjoint presence or not of particles of other types such as for example particles of the lactose type in the case of the milk industry.

According to the invention, said third enzyme solution has a pH of between 5 and 8, preferably between 6 and 7.5, preferentially between 6.5 and 7, these pH ranges enabling the enzymes chosen from the group consisting of α-polysaccharidases (lactase, amylase, alpha-glucosidase, etc.), β-polysaccharidases (β-N-acetylglucosaminidase, cellulase, hemicellulase, β-glucanase, arabanase, pectinase, chitinase, xylanase, dextranase, lysozyme, pullulanase, β-glucisidase, mannanase, etc.), oxidoreductases (laccase, etc.), lyases (pectate lyase, etc.), transferases, proteases and peptidases (metallo-protease, serine-proteases, exo-peptidase, endo-protease, cystine-protease, etc.), and lipases and esterases (lysophospholipase, phospholipase, etc.) and mixtures thereof, to have an optimum enzyme activity.

Preferably, according to the present invention, said third enzyme solution comprising at least one enzyme, chosen from the group mentioned above, is supplied and injected into a membrane filtration apparatus in which there prevails a pH of between 5 and 8, more particularly between 6.5 and 7.5. Consequently, preferably, if other enzyme solutions or solutions of another type (detergent solution, etc.) are injected into the filtration apparatus and these solutions have a pH value higher than or lower than a pH value of between 5 and 8, the injection of said third enzyme solution will have advantageously been carried out upstream of these injections of solutions in a higher or lower pH. By proceeding in this way, an optimum enzyme activity of the enzymes present in the third enzyme solution is guaranteed, these enzymes having an optimum enzyme activity for pH values lying in a pH range from 5 to 8, preferably 6.5 to 7.5.

In the context of the present invention, provision is also made for a plurality of additional steps (c′, c″, . . . ) to be able to be performed successively so as to use an entire series of enzymes, which makes it possible to refine the identification of the nature of the clogging.

In the context of the present invention, the terms first, second and third are used to make it possible to distinguish the various steps but do not necessarily impose a sequential order on these same steps.

Advantageously, the method according to the invention further comprises an initial step d) of supplying and flowing in said membrane filtration apparatus, for a fourth predetermined period time, a detergent solution comprising at least one sequestering agent and/or at least one dispersant and/or at least one wetting agent. The supply and flow of such a solution allows the detachment of easily extractable soiling in order to enable the enzymes of the enzyme solutions to more easily reach the particles with which they have an affinity at the membranes. Since it is an initial step performed upstream of the supply and flow of the enzyme solutions, preferably, said detergent solution has a pH of between 5 and 8, preferentially between 6.5 and 7.5. In this way, following the flow of the detergent solution in the filtration apparatus, a pH of between 5 and 8 prevails therein, which makes it possible to inject therein enzyme solutions comprising enzymes the enzyme activity of which is optimal at pH values of between 5 and 8, more particularly between 6.5 and 7.5. Naturally, if it is not envisaged injecting such enzyme solutions requiring a pH of between 5 and 8, the initial detergent solution may have an acid or basic pH outside the pH range from 5 to 8.

Preferably, the method according to the invention further comprises at least one step of effecting a jump in pH implemented in order to achieve a pH of between 9 and 10 by adding an alkaline compound in said membrane filtration apparatus, said jump in pH being performed:
before steps a) and/or b), or
after steps a) and/or b), or
after steps d) and/or c), steps d) and/or c), a)
   and/or b) then being carried out sequentially.

The implementation of such a jump in pH makes it possible to potentialise the enzyme activity requiring a pH of around 9 to 10 in order to have an optimum enzyme activity, as is in particular the case with proteases and lipases. This is advantageous for the purpose of reducing the quantities of consumables used, since the more effective the enzymes, the smaller the volumes that need to be injected.

According to the invention, a jump in pH may be achieved before or after step a), before or after step b), before or after steps a) and b) performed in any order, or even before or after steps a) and b) supplemented by optional steps (a′, a″, . . . and/or b′, b″, . . . ) using other enzymes.

In another case, when other enzyme solutions comprising enzymes such as those used during at least one additional step c) mentioned above are involved and since these enzymes have an optimum enzyme activity at a pH of between 6 and 8, the jump in pH will be implemented after the additional enzyme solutions are supplied (step c and optionally c′, c″, etc.).

Advantageously, the method according to the invention further comprises a final additional step of increase in pH implemented in order to achieve a pH of between 10 and 11 by adding an alkaline compound in said membrane filtration apparatus. The purpose of this final step is to solubilise the soiling (particles, etc.) remaining in suspension following the implementation of the previous steps of the method according to the invention. Since this step is performed at the end of the method, such a pH value of between 10 and 11 does not affect the enzyme activity of the enzyme solutions, which would have acted upstream of this final increase in pH.

Preferably, according to the method according to the invention, said first, second, third and fourth predetermined periods of time have a duration of between 5 and 60 minutes, preferably between 20 and 30 minutes. Such durations of flow of the enzyme solutions have been determined as being adequate so that the measurements of parameters made are representative of the activity or not of the enzymes on the particles responsible for the clogging of the membranes.

Preferably, according to the method according to the invention, at least said step a) is performed at a temperature of between 20° and 60° C., preferably between 40° and 50° C. In the context of the present invention, it has been determined that these temperature ranges are suitable for each of the steps so that the measurements of parameters made are representative of the activity or not of the enzymes on the particles responsible for the clogging of the membranes.

Advantageously, according to the method according to the invention, said enzyme solutions comprise a detergent phase as a solvent. Although the enzyme solutions may be formulated in an aqueous solution according to the invention, the enzymes may advantageously be formulated in a suitable detergent phase not minimising their enzyme activity but contributing to the detachment of the particles responsible for the clogging and to putting them in suspension.

Preferably, the method according to the invention further comprises a step of additional identification of the presence of biofilms implemented by supplying and flowing in said membrane filtration apparatus a composition comprising at least one detergent component and at least one enzyme component, said enzyme component comprising at least one laccase and/or at least one polysaccharidase and/or at least one protease and said detergent component comprising at least one sequestering compound, a dispersing compound and a wetting compound. Such an identification of the presence of biofilms makes it possible, if the biofilm is detected, to optimise the unclogging of the membranes by proceeding with an elimination of the biofilms, for example by supplying and flowing a composition for eliminating the biofilms such as the one described in document EP 2 243 821.

Preferably, the method according to the invention further comprises a step of additional identification of the presence of metal ions implemented by supplying and flowing a composition comprising a sequestering agent and/or a dispersant.

The sequestering agent is a chemical substance having the ability to form complexes with mineral ions, which it fixes in a form preventing precipitation thereof by normal reactions. By way of example, the sequestering agent may be ethylenediaminetetraacetic acid, gluconodeltalactone, sodium gluconate, potassium gluconate, calcium gluconate, citric acid, phosphoric acid, tartaric acid, sodium acetate, sorbitol or a compound comprising a phosphorus atom. The sequestering agent may also be an oxide of phosphorus such as phosphonate, phosphinate or phosphate, or a salt thereof, an amine or an amine oxide carrying at least, in its structure, one phosphine, phosphine oxide, phosphinite, phosphonate, phosphite, phosphonate, phosphinate or phosphate functional group, or a salt thereof. The sequestering agent may also be a phosphonate or a salt thereof, an amine or an amine oxide comprising at least, in its structure, a phosphine, phosphine oxide, phosphinite, phosphonite, phosphite, phosphonate, phosphinate or phosphate functional group, or a salt thereof. By way of non-limitative example, the phosphonate may be of general formula R1(R20)(R30)P=0 in which R1, R2 and R3 are independently selected from the group hydrogen, alkyl, substituted alkyl, alkyl-amino substituted or not, aminoalkyl substituted or not, aryl or substituted aryl. By way of non-limitative example, the amine or the amine oxide may comprise one, two or three substituents of general formula CR4R5W in which R4 and R5 are independently chosen from the group hydrogen, alkyl, substituted alkyl, alkyl-amino substituted or not, aminoalkyl substituted or not, aryl or substituted aryl, and W is chosen from the group phosphonate, phosphinate or phosphate. The sequestering agent may be in the form of a sodium, calcium, lithium, magnesium or potassium salt; preferentially, the sequestering agent may be in the form of a sodium, calcium or potassium salt. The dispersing agent is a chemical substance having the ability to improve the separation of the particles from a suspension in order to prevent agglutination, aggregation and/or settling. The sequestering agent may also be MGDA (methylglycinediacetic acid) and derivatives thereof, NTA (nitrilotriacetic acid) and derivatives thereof, DTPA (diethylenetriaminopentaacetic acid) and derivatives thereof, HEDTA (hydroxyethylenediaminetriacetic acid) and derivatives thereof or GLDA (glutamic acid/diacetic acid) and derivatives thereof.

The dispersing agent may be a polymer soluble or partially soluble in water such as for example polyethylene glycol, cellulose derivatives or a polymer comprising at least one acrylic acid or acrylic ester unit. The dispersing agent may be a polymer comprising at least one acrylic acid or acrylic ester unit of general formula —(CH2—CH—COOR)— in which R may be hydrogen, alkyl or substituted alkyl, aryl or substituted aryl. In particular, the dispersing agent is a polymer having a molecular mass Mw of between 500 and 10,000. The dispersing agent may also be an acrylic acid homopolymer. In particular the dispersing agent may be an acrylic acid homopolymer having a molecular mass of between 2000 and 6000.

Other embodiments of the method according to the invention are indicated in the accompanying claims.

The present invention also relates to a kit for identifying the nature of clogging present in a membrane filtration apparatus, said kit comprising at least:
a) a first enzyme solution comprising at least one protease;
b) a second enzyme solution comprising at least one enzyme other than a protease.

Preferably, according to the invention, the second enzyme solution of the kit for identifying the nature of clogging present in a membrane filtration apparatus comprises at least one enzyme chosen from the group consisting of α-polysaccharidases (lactase, amylase, alpha-glucosidase, etc.), β-polysaccharidases (β-N-acetylglucosaminidase, cellulase, hemicellulase, β-glucanase, arabanase, pectinase, chitinase, xylanase, dextranase, lysozyme, pullulanase, β-glucisidase, mannanase, etc.), oxidoreductases (laccase, etc.), lyases (pectate lyase, etc.), transferases, lipases and esterases (lysophospholipase, phospholipase, etc.) and mixtures thereof.

Preferably, the kit according to the invention further comprises a third enzyme solution comprising at least one enzyme chosen from the group consisting of α-polysaccharidases (lactase, amylase, alpha-glucosidase, etc.), β-polysaccharidases (β-N-acetylglucosaminidase, cellulase, hemicellulase, β-glucanase, arabanase, pectinase, chitinase, xylanase, dextranase, lysozyme, pullulanase, β-glucisidase, mannanase, etc.), oxidoreductases (laccase, etc.), lyases (pectate lyase, etc.), transferases, proteases and peptidases (metallo-protease, serine-proteases, exo-peptidase, endo-protease, cystine-protease, etc.), and lipases and esterases (lysophospholipase, phospholipase, etc.) and mixtures thereof.

Advantageously, the kit according to the invention further comprises a detergent solution comprising at least one sequestering agent and/or at least one dispersing agent and/or at least one wetting agent.

Preferably, the kit according to the invention further comprises a composition comprising at least one detergent component and at least one enzyme component, said enzyme component comprising at least one laccase and/or at least one polysaccharidase and/or at least one protease and said detergent component comprising at least one sequestering compound, a dispersing compound and a wetting compound.

Advantageously, the kit according to the invention further comprises a composition comprising a sequestering agent and/or a dispersing agent.

Other embodiments of the kit according to the invention are indicated in the accompanying claims.

### EXAMPLES

### Example 1

In order to determine the nature o f the clogging present in an ultrafiltration apparatus (300 litre volume) for extracting lupines, the method according to the invention was implemented according to the steps set out in the following table:

| | | | | | | |
|---|---|---|---|---|---|---|
| | | | | | pH after | |
| | Dura- | | | | injection | Flow rate |
| | tion | Product | Volume | T° | of | at |
| Step | (min) | injected | (litres) | (° C.) | product | outlet (l/h) |

Organic clogging

| | | | | | | |
|---|---|---|---|---|---|---|
| Detergent | 20 | A6 + | 0.5 (A6) + | 47.6 | 5.5 | 280 |
| base + | | D2 | 0.15 | | | |
| acidification | | | (D2) | | | |
| Cellulase | 20 | K4 | 0.15 | 47.5 | 5.1 | 426 |
| Jump in pH | 10 | K2 | 0.2 | 47.5 | 9.8 | 356 |
| Protease | 20 | K1 | 0.8 | 48 | 9.8 | 518 |
| Lipase | 20 | K3 | 0.15 | 48.5 | 9.8 | 521 |
| Rinsing | 10 | H₂O | n.a.* | 48.5 | 7 | 521 |

Metal clogging

| | | | | | | |
|---|---|---|---|---|---|---|
| Acidification | 15 | A3 | 0.25 | 41 | 3 | 760 |
| Sequestering | 20 | A4 | 0.3 | 42 | 3 | 917 |
| agent + | | | | | | |
| dispersant | | | | | | |

A6 = detergent base comprising a sequestering agent, a dispersing agent and a wetting agent
D2 = acid solution (phosphoric acid + nitric acid)
K4 = aqueous enzyme solution based on cellulase
K2 = alkaline solution (caustic soda + caustic potash)
K1 - aqueous enzyme solution based on protease
K3 = aqueous enzyme solution based on lipase
A3 = acid solution (HCl)
A4 = solution comprising a sequestering agent and a dispersing agent
n.a.* = not applicable: lost-flow circulation continuously for 10 minutes.

Implementation of the method according to the invention according to the first example showed that the clogging of the ultrafiltration apparatus is essentially due to the presence of particles having an affinity with cellulases and proteases but also because of the presence of metal ions. As can be seen from this example, a first step of injecting a detergent solution was performed, in order to at least partially detach the particles (soiling) from the filter and to keep them in suspension. A pH of 5.5 was imposed at the start of audit so that the cellulase is situated in a medium having a pH favourable to its enzyme activity. Furthermore, a jump in pH was effected before the successive injections of the enzyme solutions based on protease and lipase so that these enzymes are situated in a medium having a pH favourable to the enzyme activity. Moreover, acidification was effected before the injection of a solution comprising a sequestering agent and a dispersing agent, in order to promote the action of these agents in the possible attachment of metal ions. More specifically, the acidification was performed in order to effect a detachment of iron.

In this test, since higher flow rates at the discharge from the filtration apparatus were observed following the injection of the solution containing cellulase, the injection of the solution contained protease and the injection of the solution comprising a sequestering agent and a dispersing agent, it could be concluded that the nature of the clogging is essentially cellulosic and proteinic but that the clogging is also due to the presence of metal ions. Following this audit, a suitable solution comprising cellulases, proteases and agents for detaching the metal ions could be formulated in order to be able to act specifically against particles actually responsible for clogging.

### Example 2

In order to determine the nature of clogging present in a nanofiltration and reverse osmosis filtration apparatus (1500 litre volume) for processing milk, the method according to the invention was implemented in accordance with the steps set out in the following table:

| | | | | | | |
|---|---|---|---|---|---|---|
| | | | | | pH | Flow |
| | | | | | after | rate |
| | | | | | injection | at |
| | Duration | Injected | Volume | T° | of | outlet |
| Step | (min) | product | (litres) | (° C.) | product | (l/h) |

Organic clogging

| | | | | | | |
|---|---|---|---|---|---|---|
| Detergent | 20 | A6 | 3 | 45 | 7.57 | 6000 |
| base | | | | | | |
| Lactase | 20 | R1 | 0.9 | 30 | 7.57 | 6000 |
| Protease | 20 | R2 | 0.9 | 35 | 7.01 | 7000 |
| Lipase | 20 | R3 | 0.9 | 37.2 | 6.87 | 6500 |
| Jump in pH | 10 | K2 | 3 | 40.2 | 11.05 | 9000 |
| Rinsing | 10 | H₂O | n.a.* | 45 | 7 | 6500 |

Metal clogging

| | | | | | | |
|---|---|---|---|---|---|---|
| Sequestering | 25 | A4 | 4.5 | 34 | 10.76 | 9000 |
| agent + | | | | | | |
| dispersant + | | | | | | |
| K2 | | | | | | |

A6 = detergent base comprising a sequestering agent, a dispersing agent and a wetting agent
R1 = aqueous enzymatic solution based on lactase
K2 = alkaline solution (caustic soda + caustic potash in a ratio 1:1)
R2 = aqueous enzyme solution based on protease
R3 = aqueous enzyme solution based on lipase
A4 = solution comprising a sequestering agent and a dispersing agent
n.a.* = not applicable: lost-flow circulation continuously for 10 minutes

The implementation of the method according to the invention according this second example showed that the clogging of the nanofiltration and reverse-osmosis filtration apparatus is essentially due to the present of particles having an affinity with lipases and proteases. As can be seen from this example, a first step of injecting a detergent solution was carried out in order to at least partially detach the particles from the filter and to keep them in suspension. Furthermore, a jump in pH was carried out following the successive injections of the enzyme solutions based on protease and lipase so that these enzymes are each situated in a medium having a pH favourable to their enzyme activity.

From this test, since higher flow values at the discharge from the filtration apparatus were observed following the injection of the solution containing protease and the injection of the solution containing lipase, in association with a subsequent jump in pH, it could be concluded that the nature of the clogging is essentially proteinic and lipidic. A suitable solution comprising proteases and lipases could be formulated in order to be able to act specifically against the particles actually responsible for the clogging.

### Example 3

In order to determine the nature of the clogging present in a reverse-osmosis filtration apparatus (3000 litre volume) for treating milk, the method according to the invention was implemented according to the steps set out in the following table:

| | | | | | | |
|---|---|---|---|---|---|---|
| | | | | | pH | Flow |
| | | | | | after | rate |
| | | | | | injection | at |
| | Duration | Injected | Volume | T° | of | outlet |
| Step | (min) | product | (litres) | (° C.) | product | (l/h) |

Organic clogging

| | | | | | | |
|---|---|---|---|---|---|---|
| Detergent | 20 | A6 | 3.2 | 47.2 | 6.8 | 18 |
| base + | | | | | | |
| Lactase | 20 | R1 | 0.8 | 47.2 | 6.6 | 18 |
| Protease | 20 | R2 | 0.8 | 47.2 | 6.6 | 18 |
| Lipase | 20 | R3 | 0.8 | 47.2 | 6.6 | 18 |
| Jump in pH | 10 | K2 | 1.5 | 47.2 | 9.9 | 26 |
| Rinsing | 10 | H₂O | n.a.* | 47.2 | 7 | 26 |

Biofilm clogging

| | | | | | | |
|---|---|---|---|---|---|---|
| Biorem | 45 | B | 4 | 47.2 | 7 | 26 |
| Rinsing | 10 | H₂O | n.a.* | 47.2 | 7 | 26 |

Metal clogging

| | | | | | | |
|---|---|---|---|---|---|---|
| Sequestering | 25 | A4 | 3.7 | 47.2 | 10.1 | 35 |
| agent + | | | | | | |
| dispersant + | | | | | | |
| K2 | | | | | | |

A6 = detergent base comprising a sequestering agent, a dispersing agent and a wetting agent
R1 = aqueous enzymatic solution based on lactase
K2 = alkaline solution (caustic soda + caustic potash in a ratio 1:1)
R2 = aqueous enzyme solution based on protease
R3 = aqueous enzyme solution based on lipase
A4 = solution comprising a sequestering agent and a dispersing agent
B = composition comprising a detergent component comprising a sequestering agent, a dispersing agent and a wetting agent and an enzyme component comprising a polysaccharidase, a laccase and protease
n.a.* not applicable: lost-flow circulation continuously for 10 minutes.

The implementation of the method according to the invention according to this third example made it possible to show that the clogging of the reverse-osmosis filtration apparatus is essentially due to the presence of particles having an affinity with lipases and proteases but also because of the presence of metal ions. As can be seen from this example, a first step of injecting a detergent solution is performed, in order to at least partly detach the particles from the filter and to keep them in suspension. Furthermore, a jump in pH was effected following the successive injections of enzyme solutions based on protease and lipase so that these enzymes are situated in an environment having a pH favourable to their enzyme activity. As can be seen, the injection of a solution for showing the presence of clogging due to the presence of biofilm did not make it possible to observe a greater flow at the discharge, which results in an almost absence of biofilm in the filtration apparatus.

From this test, since the higher flow values at the discharge from the filtration installation were observed following the injection of the solution containing lipase, the injection of the solution containing the protease and the injection of the solution comprising a sequestering agent and a dispersant, it could be concluded that the nature of the clogging is essentially lipidic and proteinic but also that the clogging is due to the presence of metal ions. Following this audit, a suitable solution comprising lipases, proteases and agents for detaching the metal ions could be formulated in order to be able to act specifically against the particles actually responsible for the clogging.

Naturally the present invention is in no way limited to the embodiments described above and many modifications can be made thereto without departing from the scope of the accompanying claims.

1. Method for treating a membrane filtration apparatus having at least one fluid inlet and at least one fluid outlet, said method comprising a first step a) of supplying and flowing, through said membrane filtration apparatus for a first predetermined period of time, a first enzyme solution comprising at least one protease, said first step a) being followed by a first measurement, carried out at said at least one fluid inlet and/or at said at least one fluid outlet of said membrane filtration apparatus, of at least one first value of a parameter for characterising the fluid flowing in said membrane filtration apparatus, this at least one first measured value of a parameter being compared with a measured value of this same parameter prior to step a),
said method being characterised in that it comprises, for identifying the nature of the clogging present in said membrane filtration apparatus, a second step b) of supplying and flowing in said membrane filtration apparatus, for a second predetermined period of time, a second enzyme solution comprising at least one enzyme other than a protease, said second step b) being followed by a second measurement, carried out at said at least one fluid inlet and/or at said at least one fluid outlet of said membrane filtration apparatus, of at least one second value of a parameter for characterising the fluid flowing in said membrane filtration apparatus, this at least one second measured value of a parameter being compared with a measured value of this same parameter prior to step b), said steps a) and b) being implemented in any order.

2. Method for treating a membrane filtration apparatus according to claim 1, characterised in that said second step b) of supplying and flowing a second enzyme solution comprising at least one enzyme other than a protease is based on a supply and a flow of at least one enzyme chosen from the group consisting of α-polysaccharidases (lactase, amylase, alpha-glucosidase, etc.), β-polysaccharidases (β-N-acetylglucosaminidase, cellulase, hemicellulase, β-glucanase, arabanase, pectinase, chitinase, xylanase, dextranase, lysozyme, pullulanase, β-glucisidase, mannanase, etc.), oxidoreductases (laccase, etc.), lyases (pectate lyase, etc.), transferases, lipases and esterases (lysophospholipase, phospholipase, etc.) and mixtures thereof.

3. Method for treating a membrane filtration apparatus according to claim 1, characterised in that it also comprises at least one additional step c) of supplying and flowing in said membrane filtration apparatus for a third predetermined period of time a third enzyme solution comprising at least one enzyme chosen from the group consisting of α-polysaccharidases (lactase, amylase, alpha-glucosidase, etc.), β-polysaccharidases (β-N-acetylglucosaminidase, cellulase, hemicellulase, β-glucanase, arabanase, pectinase, chitinase, xylanase, dextranase, lysozyme, pullulanase, β-glucisidase, mannanase, etc.), oxidoreductases (laccase, etc.), lyases (pectate lyase, etc.), transferases, proteases and peptidases (metallo-protease, serine-proteases, exo-peptidase, endo-protease, cystine-protease, etc.), and lipases and esterases (lysophospholipase, phospholipase, etc.) and mixtures thereof, an additional measurement of at least one value of a parameter, making it possible to characterise the fluid flowing in said membrane filtration apparatus, then being able to be carried out at said at least one fluid inlet and/or said at least one fluid outlet of said membrane filtration apparatus following this additional step c), this at least one measured value of a parameter being compared with a measured value of this same parameter prior to this additional step c).

4. Method for treating a membrane filtration apparatus according to claim 1, characterised in that it further comprises an initial step d) of supplying and flowing in said membrane filtration apparatus, for a fourth predetermined period time, a detergent solution comprising at least one sequestering agent and/or at least one dispersant and/or at least one wetting agent.

5. Method for treating a membrane filtration apparatus according to claim 1, characterised in that it further comprises at least one step of effecting a jump in pH implemented in order to achieve a pH of between 9 and 10 by adding an alkaline compound in said membrane filtration apparatus, said jump in pH being performed:
before steps a) and/or b), or
after steps a) and/or b), or
after steps d) and/or c), steps d) and/or c), a) and/or b) then being carried out sequentially.

6. Method for treating a membrane filtration apparatus according to claim 1, characterised in that it further comprises a final additional step of increase in pH in order to achieve a pH of between 10 and 11 by adding an alkaline compound in said membrane filtration apparatus.

7. Method for treating a membrane filtration apparatus according to claim 1, characterised in that said first, second, third and fourth predetermined periods of time have a duration of between 5 and 60 minutes, preferably between 20 and 30 minutes.

8. Method for treating a membrane filtration apparatus according to claim 1, characterised in that at least said step a) is performed at a temperature of between 20° and 60° C., preferably between 40° and 50° C.

9. Method for treating a membrane filtration apparatus according to claim 1, characterised in that said enzyme solutions comprise a detergent phase as a solvent.

10. Method for treating a membrane filtration apparatus according to claim 1, characterised in that an additional identification of the presence of biofilms implemented by supplying and flowing in said membrane filtration apparatus a composition comprising at least one detergent component and at least one enzyme component, said enzyme component comprising at least one laccase and/or at least one polysaccharidase and/or at least one protease and said detergent component comprising at least one sequestering compound, a dispersing compound and a wetting compound.

11. Method for treating a membrane filtration apparatus according to claim 1, characterised in that an additional identification of the presence of metal ions is implemented by supplying and flowing a composition comprising a sequestering agent and/or a dispersant.

12. Kit for identifying the nature of clogging present in a membrane filtration apparatus, said kit comprising at least:
c) a first enzyme solution comprising at least one protease;
d) a second enzyme solution comprising at least one enzyme other than a protease.

13. Kit for identifying the nature of clogging present in a membrane filtration apparatus according to claim 12, characterised in that said at least one enzyme other than a protease is chosen from the group consisting of α-polysaccharidases (lactase, amylase, alpha-glucosidase, etc.), β-polysaccharidases (β-N-acetylglucosaminidase, cellulase, hemicellulase, β-glucanase, arabanase, pectinase, chitinase, xylanase, dextranase, lysozyme, pullulanase, β-glucisidase, mannanase, etc.), oxidoreductases (laccase, etc.), lyases (pectate lyase, etc.), transferases, lipases and esterases (lysophospholipase, phospholipase, etc.) and mixtures thereof.

14. Kit for identifying the nature of clogging present in a membrane filtration apparatus according to claim 12, characterised in that it further comprises a third enzyme solution comprising at least one enzyme chosen from the group consisting of α-polysaccharidases (lactase, amylase, alpha-glucosidase, etc.), β-polysaccharidases (β-N-acetylglucosaminidase, cellulase, hemicellulase, β-glucanase, arabanase, pectinase, chitinase, xylanase, dextranase, lysozyme, pullulanase, β-glucisidase, mannanase, etc.), oxidoreductases (laccase, etc.), lyases (pectate lyase, etc.), transferases, proteases and peptidases (metallo-protease, serine-proteases, exo-peptidase, endo-protease, cystine-protease, etc.), and lipases and esterases (lysophospholipase, phospholipase, etc.) and mixtures thereof.

15. Kit for identifying the nature of clogging present in a membrane filtration apparatus according to claim 12, further comprising a detergent solution comprising at least one sequestering agent and/or at least one dispersing agent and/or at least one wetting agent.

16. Kit for identifying the nature of clogging present in a membrane filtration apparatus according to claim 12, further comprising a detergent solution comprising at least one detergent component and at least one enzyme component, said enzyme component comprising at least one laccase and/or at least one polysaccharidase and/or at least one protease and said detergent component comprising at least one sequestering compound, a dispersing compound and a wetting compound.

17. Kit for identifying the nature of clogging present in a membrane filtration apparatus according to claim 12, further comprising a detergent solution comprising a composition comprising a sequestering agent and/or a dispersing agent.
